(19) United States
(12) Patent Application Publication
(10) Pub. No.: US 2024/0241295 A1
(43) Pub. Date: Jul. 18, 2024

(54) ELECTRONIC DEVICE

(71) Applicant: InnoLux Corporation, Miao-Li County (TW)

(72) Inventors: Chia-Hsien HSIEH, Miao-Li County (TW); Hong-Sheng HSIEH, Miao-Li County (TW)

(73) Assignee: InnoLux Corporation, Miao-Li County (TW)

(21) Appl. No.: 18/536,260

(22) Filed: Dec. 12, 2023

(30) Foreign Application Priority Data
Jan. 13, 2023 (CN) 202310065428.3

(51) Int. Cl. G02B 5/02

(52) U.S. Cl. CPC G02B 5/0221; G02B 5/0231; G02B 5/0278

(57) ABSTRACT

An electronic device has a first region, a second region and a third region arranged in sequence along a direction. The electronic device includes a panel and an optical film. The optical film is disposed corresponding to the panel. The optical film includes a first blocking wall, a second blocking wall and a third blocking wall respectively corresponding to the first region, the second region and the third region, and the first blocking wall, the second blocking wall and the third blocking wall are configured to vary gradually in structures.

### BACKGROUND OF THE DISCLOSURE

### 1. Field of the Disclosure

The present disclosure relates to an electronic device, and more particularly, to an electronic device having a light modulating structure.

### 2. Description of the Prior Art

With the advancement of technology, electronic devices equipped with displays have become indispensable in modern life. When the electronic device is disposed at a position that does not allow a user to directly face a central region of the electronic device, it is unfavorable for the user to see the image of the electronic device clearly. Alternatively, when the user uses the electronic device when there are bystanders around, the user's privacy may be peeped by the bystanders.

Therefore, how to control the emitting directions of the emitting lights of the electronic device toward the user, so as to improve the user's experience while protecting the privacy of the user, has become an important subject.

### SUMMARY OF THE DISCLOSURE

According to an embodiment of the present disclosure, an electronic device has a first region, a second region and a third region arranged in sequence along a direction. The electronic device includes a panel and an optical film. The optical film is disposed corresponding to the panel. The optical film includes a first blocking wall, a second blocking wall and a third blocking wall respectively corresponding to the first region, the second region and the third region, and the first blocking wall, the second blocking wall and the third blocking wall are configured to vary gradually in structures.

According to another embodiment of the present disclosure, an electronic device has a first region, a second region and a third region arranged in sequence along a direction. The electronic device includes a panel and an optical film. The optical film is disposed corresponding to the panel. The first region has a first emitting light, the second region has a second emitting light, the third region has a third emitting light, and the first emitting light, the second emitting light and the third emitting light are configured to vary gradually.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a schematic diagram showing a partial cross-sectional view of an electronic device according to an embodiment of the present disclosure.

FIG. is a schematic diagram showing a partial cross-sectional view of an optical film according to an embodiment of the present disclosure.

FIG. 3 is a schematic diagram showing a partial cross-sectional view of an optical film according to an embodiment of the present disclosure.

FIG. 4 is a schematic showing a partial diagram cross-sectional view of an optical film according to an embodiment of the present disclosure.

FIG. 5 is a schematic diagram showing a partial cross-sectional view of an optical film according to an embodiment of the present disclosure.

FIG. 6 is a schematic diagram showing a partial cross-sectional view of an optical film according to an embodiment of the present disclosure.

FIG. 7 is a schematic diagram showing a partial cross-sectional view of an optical film according to an embodiment of the present disclosure.

FIG. 8 is an intensity-angle distribution diagram of an emitting light according to an embodiment of the present disclosure.

FIG. 9 is a schematic diagram showing light shapes of an electronic device according to an embodiment of the present disclosure.

FIG. 10 is a schematic diagram showing normal intensities of an electronic device according to an embodiment of the present disclosure.

### DETAILED DESCRIPTION

The present disclosure may be understood by reference to the following detailed description, taken in conjunction with the drawings as described below. Wherever possible, the same or similar parts in the drawings and descriptions are represented by the same reference numeral.

Certain terms are used throughout the description and following claims to refer to particular components. As one skilled in the art will understand, electronic equipment manufacturers may refer to a component by different names. This document does not intend to distinguish between components that differ in name but not function. In the following description and in the claims, the terms “include/comprise” and “have” are used in an open-ended fashion, and thus should be interpreted to mean “include, but not limited to . . . ”.

In the present disclosure, the directional terms, such as “on/up/above”, “down/below”, “front”, “rear/back”, “left”, “right”, etc., are only directions referring to the drawings. Therefore, the directional terms are used for explaining and not used for limiting the present disclosure. Regarding the drawings, the drawings show the general characteristics of methods, structures, and/or materials used in specific embodiments. However, the drawings should not be construed as defining or limiting the scope or properties encompassed by these embodiments. For example, for clarity, the relative size, thickness, and position of each layer, each area, and/or each structure may be reduced or enlarged.

In the present disclosure, when a structure (or layer, or component, or substrate) is described as located on/above another structure (or layer, or component, or substrate), it may refer that the two structures are adjacent and directly connected with each other, or the two structures are adjacent and indirectly connected with each other. The two structures being indirectly connected with each other may refer that at least one intervening structure (or intervening layer, or intervening component, or intervening substrate, or intervening interval) exists between the two structures, a lower surface of one of the two structure is adjacent or directly connected with an upper surface of the intervening structure, and an upper surface of the other of the two structures is adjacent or directly connected with a lower surface of the intervening structure. The intervening structure may be a single-layer or multi-layer physical structure or a non-physical structure, and the present disclosure is not limited thereto. In the present disclosure, when a certain structure is disposed “on/above” other structures, it may refer that the certain structure is “directly” disposed on/above the other structures, or the certain structure is “indirectly” disposed on/above the other structures, i.e., at least one structure is disposed between the certain structure and the other structures.

The terms “about”, “equal”, “identical” or “the same”, or “substantially” or “approximately” mentioned in this document generally mean being within 20% of a given value or range, or being within 10%, 5%, 3%, 2%, 1% or 0.5% of the given value or range.

Furthermore, any two values or directions used for comparison may have a certain error. If a first value is equal to a second value, it implies that there may be an error of about 10% between the first value and the second value; if a first direction is perpendicular or “substantially” perpendicular to a second direction, then an angle included between the first direction and the second direction may be between 80 degrees to 100 degrees; if the first direction is parallel or “substantially” parallel to the second direction, an angle included between the first direction and the second direction may be between 0 degree to 10 degrees.

Although ordinal numbers such as “first”, “second”, etc., may be used to describe elements in the description and the claims, it does not imply and represent that there have other previous ordinal number. The ordinal numbers do not represent the order of the elements or the manufacturing order of the elements. The ordinal numbers are only used for discriminate an element with a certain designation from another element with the same designation. The claims and the description may not use the same terms. Accordingly, a first element in the description may be a second element in the claims.

In addition, the term “a given range is from a first value to the second value” or “a given range falls within a range from a first value to a second value” refers that the given range includes the first value, the second value and other values therebetween.

Moreover, the electronic device of the present disclosure may include a display device, a backlight device, an antenna device, a sensing device, a tiled device, a touch display device, a curved display device or a free shape display device, but not limited thereto. The electronic device may exemplarily include liquid crystal, light emitting diode, fluorescence, phosphor, other suitable display media or a combination thereof, but not limited thereto. The display device may be a non-self-luminous type display device or a self-luminous type display device. The antenna device may be a liquid-crystal-type antenna device or a non-liquid-crystal-type antenna device. The sensing device may be a device for sensing capacitance, light, thermal or ultrasonic, but not limited thereto. The electronic components of the electronic device may include passive components and active components, such as capacitors, resistors, inductors, diodes, transistors, etc., but not limited thereto. The diode may include a light emitting diode (LED) or a photodiode. The light emitting diode may include organic light emitting diode (OLED), mini LED, micro LED or quantum dot LED, but not limited thereto. The tiled device may exemplarily be a tiled display device or a tiled antenna device, but not limited thereto. Furthermore, the electronic device may be any combination of aforementioned devices, but not limited thereto. Furthermore, the electronic devices may be foldable or flexible electronic devices. The electronic device may be any combination of aforementioned devices, but not limited thereto. Furthermore, a shape of the electronic device may be a rectangle, a circle, a polygon, a shape with curved edge or other suitable shape. The electronic device may have peripheral systems, such as a driving system, a control system, shelf system, a light system, etc., for supporting the display device, the antenna device or the tiled device.

In the present disclosure, it should be understood that a depth, a thickness, a width or a height of each element, or a space or a distance between elements may be measured by an optical microscopy (OM), a scanning electron microscope (SEM), a film thickness profiler (a-step), an ellipsometer or other suitable methods. In some embodiments, a cross-sectional image including elements to be measured can be obtained by the SEM, and the depth, the thickness, the width or the height of each element, or the space or the distance between elements can be measured thereby.

It should be noted that the technical features in different embodiments described in the following can be replaced, recombined, or mixed with one another to constitute another embodiment without departing from the spirit of the present disclosure.

Unless otherwise defined, all terms (including technical and scientific terms) used herein have the same meaning as commonly understood by a person having ordinary skill in the art to which the disclosure belongs. It can be understood that these terms, such as those defined in commonly used dictionaries, should be interpreted as having meanings consistent with the background or context of the related technology and the present disclosure, and should not be interpreted in an idealized or overly formal manner, unless otherwise specified in the disclosed embodiments.

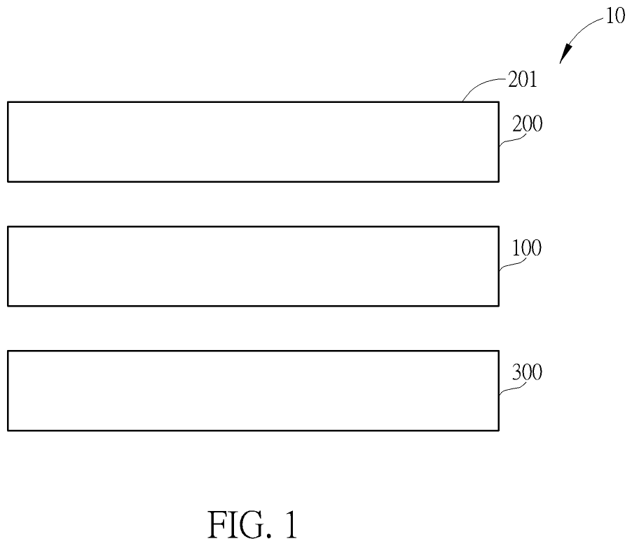

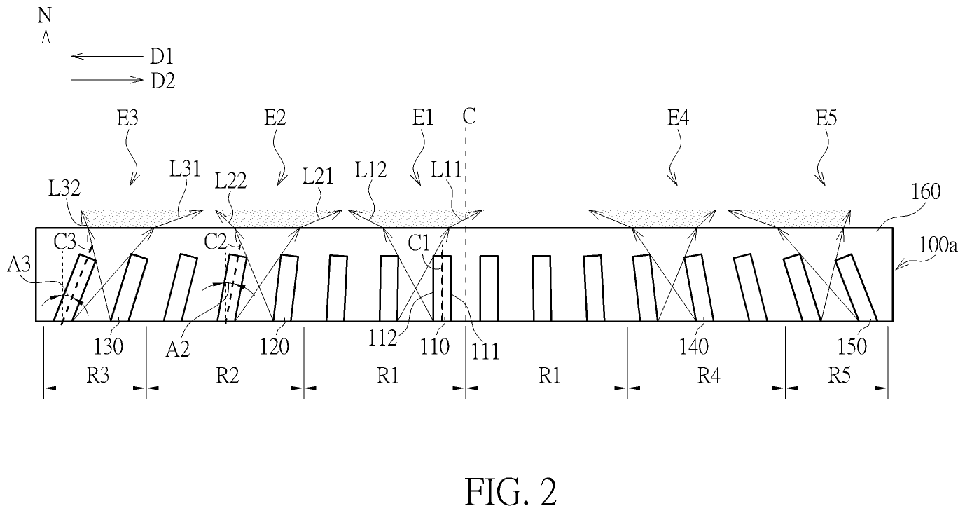

Please refer to FIG. 1, which is a schematic diagram showing a partial cross-sectional view of an electronic device 10 according to an embodiment of the present disclosure. In the embodiment, the electronic device 10 is applied as a display device, and has a light modulating structure capable of adjusting emitting light of the display device. For example, the light modulating structure can be an optical film having blocking walls, but not limited thereto. The electronic device 10 may also include other functions, such as touch and detection, but not limited thereto. The electronic device 10 includes a panel 200, an optical film 100 and can selectively include a backlight module 300. The optical film 100 is disposed corresponding to the panel 200. The backlight module 300 is disposed corresponding to the optical film 100 and/or the panel 200. That is, the electronic device 10 may be a self-luminous type display device or a non-self-luminous type display device. In the embodiment, the electronic device 10 may be a non-self-luminous type display device, the panel 200 may exemplarily include (but does not limit to) a liquid crystal panel, and the electronic device 10 may include the backlight module 300. As shown in FIG. 1, the optical film 100 may be disposed between the panel 200 and the backlight module 300. The upper surface 201 of the panel 200 may be used as a luminous surface of the electronic device 10, i.e., the view surface of the user. When the electronic device 10 is applied as a display device, the surface 201 may be regarded as a display surface of the electronic device 10. In other embodiments, the panel 200 can be disposed above the backlight module 300, and the optical film 100 can be disposed above the panel 200. Thereby, the optical film 100 is extra added or replaceable. For another example, the electronic device 10 can be a self-luminous display device. In this case, the electronic device 10 does not require the backlight module 300, and the optical film 100 can be disposed above the panel 200. The panel 200 can be, but not limited to, an OLDE panel or a micro LED panel. In FIG. 1, the panel 200, the optical film 100 and the backlight module 300 of the electronic device 10 are spaced apart from each other. However, the three components can be closely adjacent to each other from top to bottom, or only a small interval is between any two of the three components adjacent to each other. For details of the optical film 100, reference may be made to the relevant descriptions of the optical film 100a, the optical film 100b, the optical film 100c, the optical film 100d, the optical film 100e and the optical film 100f below.

Please refer to FIG. 2, which is a schematic diagram showing a partial cross-sectional view of an optical film 100a according to an embodiment of the present disclosure. The optical film 100a can be applied to the electronic device 10 in FIG. 1. That is, the optical film 100 in FIG. 1 can be the optical film 100a. The electronic device 10 has a first region R1, a second region R2 and a third region R3 arranged in sequence along a direction D1. Since the electronic device 10 includes the optical film 100a, the first region R1, the second region R2 and the third region R3 can also correspond to the optical film 100a and arranged in sequence along the direction D1. The optical film 100a includes a first blocking wall 110, a second blocking wall 120 and a third blocking wall 130 respectively corresponding to the first region R1, the second region R2 and the third region R3, and the first blocking wall 110, the second blocking wall 120 and the third blocking wall 130 are configured to vary gradually in structures. Thereby, it is beneficial to control the emitting direction of the emitting light of the electronic device 10, such that the emitting light of the electronic device 10 can emit toward the user, and/or the optical characteristics of the emitting light can vary gradually.

The optical film 100a has a normal direction N, and the electronic device 10 also has a normal direction (not labeled). The normal direction N of the optical film 100a is substantially parallel to the normal direction of the electronic device 10, wherein the normal direction of the electronic device 10 is the direction of normal view angle of the emitting light that emits toward the user. The direction D1 is perpendicular to the normal direction N, and the direction D2 is perpendicular to the normal direction N and opposite to the direction D1.

Furthermore, the first region R1, the second region R2 and the third region R3 can correspond to the display region of the electronic device 10. In the embodiment, the first region R1, the second region R2 and the third region R3 only correspond to a portion of the display region. For example, the first region R1, the second region R2 and the third region R3 are arranged in sequence from a center of the display region of electronic device 10 to an end of the display region of electronic device 10 along the direction D1 perpendicular to the normal direction N. In another embodiment, the first region R1, the second region R2, and the third region R3 can correspond to the entire display region. For example, the first region R1, the second region R2, and the third region R3 are arranged in sequence from an end of the display region of the electronic device 10 to another end of the display region of the electronic device 10 along a direction (such as the direction D1 or the direction D2) perpendicular to the normal direction N, but not limited thereto. In other words, the first region R1, the second region R2 and the third region R3 can be arranged from a central region of the electronic device 10 to a peripheral region of the electronic device 10, or the first region R1, the second region R2 and the third region R3 can be arranged from a peripheral region of the electronic device 10 to another peripheral region of the electronic device 10.

Please refer to FIG. 2. In one embodiment, the structures of the blocking walls of the first region R1, the second region R2, and the third region R3 vary gradually along a direction. For example, the definition of the first region R1 can be as follows. First, start from the central axis C of the optical film 100a along the direction D1 to find a first blocking wall and another blocking wall that is firstly found to be different from the first blocking wall in structure. The difference in structure between the two blocking walls (i.e., the first blocking wall and the another blocking wall) is used as a reference value, and continue to find further another blocking wall along the direction D1, wherein the difference in structure between the further another blocking wall and the first blocking wall exceeds (100n±20) % of the reference value, wherein n is a positive integer, such as 1, 2, 3, 5, 20, 30, 50 and 100, but not limited thereto. The blocking wall prior to the further another blocking wall is called the last blocking wall. The region between the first blocking wall and the last blocking wall is defined as the first region R1. Next, start from the last blocking wall of the first region R1 along the direction D1 to find a next blocking wall as the first blocking wall of the second region R2, and the second region R2 and the third region R3 can be defined in a similar way, which are omitted herein. In other words, the difference in structure between the first blocking walls of two adjacent regions (such as the first region R1 and the second region R2, or the second region R2 and the third region R3) may be greater than (100n±20) % of the reference value. The difference in structure can be, for example, the difference of inclined angles of two blocking walls relative to the normal direction N, the difference of heights of two blocking walls, the difference of intervals between two blocking walls, but not limited thereto. Moreover, in other embodiments, the aforementioned “20%” can also be 15%, 10%, 5%, 3%, 2%, 1% or 0.5%, but not limited thereto. In the embodiment, the central axis C of the optical film 100a is used as the starting point. In some embodiments, the first blocking wall can be found along the direction D1 from the right end of the optical film 100a. Alternatively, the first blocking wall can be found along the direction D2 from the left end of the optical film 100a.

In one embodiment, “changing gradually” in the first region R1, the second region R2 and the third region R3 can be defined as follows. First, find the first blocking walls of the first region R1, the second region R2 and the third region R3 along the first direction D1, respectively. There is a difference between two first blocking walls of any two of the first region R1, the second region R2 and the third region R3 adjacent to each other, and when the differences are the same, the structures of the first region R1, the second region R2 and the third region R3 can be regarded as changing gradually. The difference, for example, can be the difference between inclined angles, or the difference between heights, the difference between intervals between the first blocking walls and the second blocking walls, but not limited thereto. The difference may have an error, such as an error within 20%. The error within 20% can be interpreted as being within 15%, 10%, 5%, 3%, 2%, 1% or 0.5% of the given value or range. Furthermore, the first blocking walls above is exemplary, and can be replaced by the central blocking wall in each region, the last blocking wall in each region, or the blocking wall having identical ordinal number in each region, and the present disclosure is not limited thereto.

The first region R1 has a first emitting light E1, the second region R2 has a second emitting light E2, the third region R3 has a third emitting light E3, and the first emitting light E1, the second emitting light E2 and the third emitting light E3 may be emitted by light emitting elements (not shown) of the electronic device 10. The structures of the first blocking wall 110, the second blocking wall 120 and the third blocking wall 130 are configured to allow emitting directions of the first emitting light E1, the second emitting light E2 and the third emitting light E3 to vary gradually. Specifically, the emitting light (the first emitting light E1, the second emitting light E2 or the third emitting light E3) of each region (the first region R1, the second region R2 or the third region R3) is a set of a plurality of rays. Herein, only the first right boundary ray L11 and the first left boundary ray L12 of the first emitting light E1, the second right boundary ray L21 and the second left boundary ray L22 of the second emitting light E2, the third right boundary ray L31 and the third left boundary ray L32 of the third emitting light E3 are shown, and the coverage ranges of the first emitting light E1, the second emitting light E2 and the third emitting light E3 close to the optical film 100a are presented by sprinkled dots, which are exemplary.

In the aforementioned statement of “the structures of the first blocking wall 110, the second blocking wall 120 and the third blocking wall 130 are configured to allow the emitting directions of the first emitting light E1, the second emitting light E2 and the third emitting light E3 to vary gradually”, “the emitting directions . . . to vary gradually” may be a result obtained by comparing specific rays that meet a specific condition in each region. For example, the first right boundary ray L11, the second right boundary ray L21 and the third right boundary ray L31 can be compared. As shown in FIG. 2, the angles of the first right boundary ray L11, the second right boundary ray L21 and the third right boundary ray L31 deviating from the normal direction N increase gradually. For another example, the first left boundary ray L12, the second left boundary ray L22 and the third left boundary ray L32 can be compared. As shown in FIG. 2, the angles of the first left boundary ray L12, the second left boundary ray L22 and the third left boundary ray L32 deviating from the normal direction N decrease gradually. For yet another example, the coverage ranges of the first emitting light E1, the second emitting light E2 and the third emitting light E3 vary gradually. As shown in FIG. 2, the asymmetry degrees or deflection degrees of the coverage ranges of the first emitting light E1, the second emitting light E2 and the third emitting light E3 increase gradually. That is, the light shapes of the first emitting light E1, the second emitting light E2 and the third emitting light E3 change from substantially symmetrical to asymmetric or deflect, and the deflection degrees increase gradually.

A first angle (not labeled) is included between the first blocking wall 110 and the normal direction N. Herein, the first blocking wall 110 is parallel to the normal direction N, and the first angle is 0 degrees. A second angle A2 is included between the second blocking wall 120 and the normal direction N. A third angle A3 is included between the third blocking wall 130 and the normal direction N. The first angle is less than the second angle A2, and the second angle A2 is less than the third angle A3. In other words, the first blocking wall 110, the second blocking wall 120 and the third blocking wall 130 are configured to vary gradually in structures. In the embodiment, the inclined angles of the first blocking wall 110, the second blocking wall 120 and the third blocking wall 130 relative to the normal direction are configured to vary gradually. Specifically, the first angle can be the angle included between the central axis C1 of the first blocking wall 110 and the normal direction N. The second angle A2 can be the angle included between the central axis C2 of the second blocking wall 120 and the normal direction N. The third angle A3 can be the angle included between the central axis C3 of the third blocking wall 130 and the normal direction N, but not limited thereto. The central axis is a connection line of the midpoints of the two boundaries of the blocking wall in the direction perpendicular to an extending direction of the blocking wall. For example, in the embodiment, the cross section of the first blocking wall 110 is substantially a rectangle, the first angle can also be the angle included between the right side 111 of the first blocking wall 110 and the normal direction N. Alternatively, the first angle can be the angle included between the left side 112 of the first blocking wall 110 and the normal direction N. In the embodiment, the cross sections of the first blocking wall 110, the second blocking wall 120 and the third blocking wall 130 are substantially rectangles. However, the present disclosure is not limited thereto. The cross sections of the first blocking wall 110, the second blocking wall 120 and the third blocking wall 130 can be independently formed in other shapes. For example, the cross sections of the first blocking wall 110, the second blocking wall 120 and the third blocking wall 130 can be substantially formed in geometric shapes of triangle and trapezoid. The cross sections of the first blocking wall 110, the second blocking wall 120 and the third blocking wall 130 can be substantially formed in geometric shapes of rectangle, triangle and trapezoid referring that the cross sections of the first blocking wall 110, the second blocking wall 120 and the third blocking wall 130 may not be perfect geometric shapes. For example, the corners of the cross section may be round corners or chamfers, such that the shape of the cross section is close to a geometric shape. In some embodiments, the first angle can also be the angle included between the extending direction of the first blocking wall 110 and the normal direction N. Similarly, the second angle A2 can also be the angle included between the extending direction of the second blocking wall 120 and the normal direction N, and the third angle A3 can also be the angle included between the extending direction of the third blocking wall 130 and the normal direction N.

In FIG. 2, the number of the first blocking walls 110 of the first region R1 is three, and the inclined angles of the three first blocking walls 110 relative to the normal direction N vary gradually (herein, increase gradually along the direction D1), the number of the second blocking walls 120 of the second region R2 is three, and the inclined angles of the three second blocking walls 120 relative to the normal direction N vary gradually (herein, increase gradually along the direction D1), the number of the third blocking walls 130 of the third region R3 is two, and the inclined angles of the two third blocking walls 130 relative to the normal direction N vary gradually (herein, increase gradually along the direction D1). However, it is exemplary. The number of the blocking walls in each region and the inclined angle of each blocking wall relative to the normal direction N can be adjusted according to practical need. When a region is disposed with a plurality of blocking walls, the inclined angles of the plurality of blocking walls relative to the normal direction N can be the same. Alternatively, the inclined angles of the plurality of blocking walls relative to the normal direction N can be configured to vary gradually along one direction. Alternatively, the inclined angles of a portion of the plurality of blocking walls relative to the normal direction N can be configured to be the same, and the inclined angles of another portion of the plurality of blocking walls relative to the normal direction N can be configured to vary gradually along one direction. Moreover, the number of the blocking walls in different regions may be the same or different. In one embodiment, changing gradually of the inclined angles of the blocking walls adjacent to each other in each region can be defined by the following formula. Select any two blocking walls in an identical region (R1, R2 or R3). The difference of the inclined angles between the two blocking walls is θ, the number of blocking walls covered by the two blocking walls is Q, then the difference of the inclined angles between any two adjacent blocking walls in the region can satisfy the following formula: [θ/(Q−1)]×(1±20%).

For example, the first blocking wall and the third blocking wall in an identical region are selected. The difference of the inclined angles between the first blocking wall and the third blocking wall is 10 degrees. The number of blocking walls covered by the first blocking wall and the third blocking wall is 3 (i.e., the three blocking walls are the first blocking wall, the second blocking wall and the third blocking wall). According to the aforementioned formula, the difference of the inclined angles between any two adjacent blocking walls is 4 degrees to 6 degrees. In the embodiment, the central region of the electronic device 10 is preset as the main view region. That is, the user faces the central region of the electronic device 10 when using the electronic device 10. Therefore, the first region R1, the second region R2, and the third region R3 are arranged from the central region of the electronic device 10 to a peripheral region of the electronic device 10. That is, the first region R1 is closer to the central region of the electronic device 10 than the second region R2, and the second region R2 is closer to the central region than the third region R3. The structures of first blocking walls 110, the second blocking walls 120 and the third blocking walls 130 are configured to allow the emitting directions of the first emitting light E1, the second emitting light E2 and the third emitting light E3 to concentrate toward the central region of the electronic device 10 and not to emit toward the peripheral region. More specifically, the normal intensity in the central region of the electronic device 10 is stronger than that in the peripheral region of the electronic device 10. It is difficult for bystanders to clearly see the display content of the electronic device 10, such that the electronic device 10 has an anti-peeping function, but the present disclosure is not limited thereto. The intensity can be measured by an optical angle measuring instrument, which is described in detail below. In other embodiment, the disposed direction of the first region R1, the second region R2, and the third region R3 can be adjusted according to the preset main view region, such as the left region of the electronic device 10. Moreover, the “±20%” in the aforementioned formula can be ±15%, +10%, +5%, +3%, +2%, +1% or +0.5% in other embodiments, but not limited thereto.

In the embodiment, the optical film 100a may further include a transparent portion 160, and the first blocking walls 110, the second blocking walls 120, and the third blocking walls 130 are disposed in the transparent portion 160. The first blocking walls 110, the second blocking walls 120 and the third blocking walls 130 may independently include an absorbing material or a reflective material. In some embodiments, the absorbing material, for example, includes a black ink, a black photoresist, other suitable material, or a combination thereof. In some embodiments, the reflective material, for example, includes a white reflective material, a metal reflective material, other suitable material, or a combination thereof. Herein, the “absorbing material”, for example, refers to a material having a transmittance for visible light (such as the visible light with a wavelength of 550 nm) greater than or equal to 0% and less than 60%, but not limited thereto. Herein, the “reflective material” may be a material with a reflectivity for visible light (such as the visible light with a wavelength of 550 nm) greater than or equal to 60% and less than or equal to 100%, but not limited thereto. The material of the transparent portion 160 may include, but not limited to, a transparent encapsulation material, such as transparent resin or silicone. The refractive index of transparent portion 160 can be 1.45 to 1.65.

In the embodiment, the electronic device 10 may further have another first region R1, a fourth region R4 and a fifth region R5 located on the right side of the central axis C. The first region R1, the fourth region R4 and the fifth region R5 are arranged in sequence along the direction D2. The optical film 100a may further include a fourth blocking wall 140 and a fifth blocking wall 150 respectively corresponding to the fourth region R4 and the fifth region R5. The fourth region R4 has a fourth emitting light E4. The fifth region R5 has a fifth emitting light E5. The fourth emitting light E4 and the fifth emitting light E5 may be emitted by the light emitting elements (not shown) of the electronic device 10. The first blocking wall 110, the fourth blocking wall 140 and the fifth blocking wall 150 are configured to vary gradually in structures, so that the emitting directions and the light shapes of the first emitting light E1, the fourth emitting light E4 and the fifth emitting light E5 vary gradually. In the embodiment, the central region of the electronic device 10 is preset as the main view region. Herein, the first blocking walls 110 of the two first region R1 are configured to be symmetrical with respect to the central axis C, the second blocking walls 120 and the fourth blocking walls 140 are configured to be symmetrical with respect to the central axis C, the third blocking walls 130 and the fifth blocking walls 150 are configured to be symmetrical with respect to the central axis C, such that the two first emitting lights E1 are symmetrical with respect to the central axis C, the fourth emitting light E4 and the second emitting light E2 are symmetrical with respect to the central axis C, and the fifth emitting light E5 and the third emitting light E3 are symmetrical with respect to the central axis C. However, the present disclosure is not limited thereto. In other embodiment, the fourth emitting light E4 and the second emitting light E2, the fifth emitting light E5 and the third emitting light E3 can be asymmetrically with respect to the central axis C.

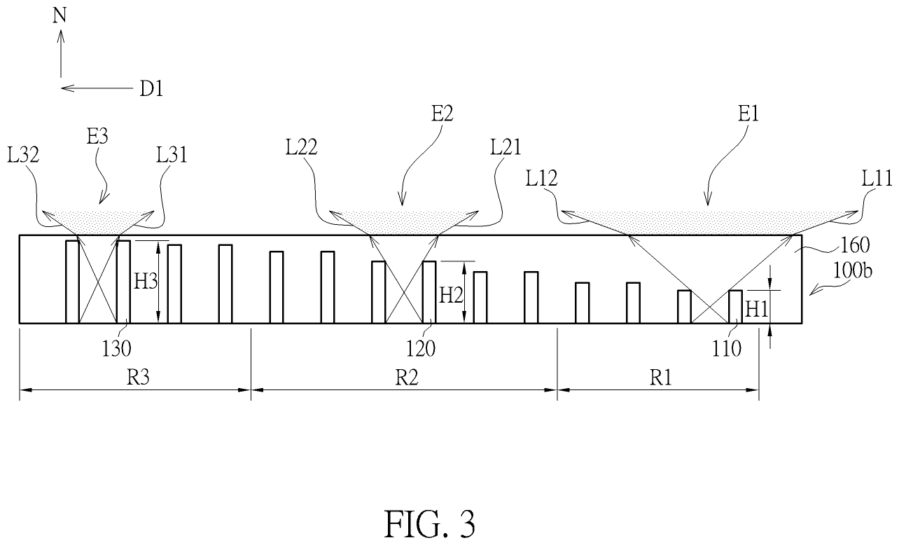

Please refer to FIG. 3, which is a schematic diagram showing a partial cross-sectional view of an optical film 100b according to an embodiment of the present disclosure. The optical film 100b can be applied to the electronic device 10 in FIG. 1. That is, the optical film 100 in FIG. 1 can be the optical film 100b. The electronic device 10 has a first region R1, a second region R2 and a third region R3 arranged in sequence along a direction D1. Since the electronic device 10 includes the optical film 100b, the first region R1, the second region R2 and the third region R3 can also correspond to the optical film 100b and arranged in sequence along the direction D1. Herein, the first region R1, the second region R2 and the third region R3 are disposed continuously from one end (such as the right end in FIG. 3) to the other end (such as the left end in FIG. 3) of the optical film 100b, which is exemplary. The optical film 100b includes a first blocking wall 110, a second blocking wall 120 and a third blocking wall 130 respectively corresponding to the first region R1, the second region R2 and the third region R3, and the first blocking wall 110, the second blocking wall 120 and the third blocking wall 130 are configured to vary gradually in structures. The first blocking wall 110 has a first height H1, the second blocking wall 120 has a second height H2, the third blocking wall 130 has a third height H3, the first height H1 is less than the second height H2, and the second height H2 is less than the third height H3. In other words, in the embodiment, the heights of the first blocking wall 110, the second blocking wall 120 and the third blocking wall 130 are configured to vary gradually. The aforementioned height of the blocking wall may be a length of the blocking wall along the normal direction N.

In FIG. 3, the number of the first blocking walls 110 in the first region R1 is four, the first heights H1 of the two first blocking walls 110 on the right side are the same, the first heights H1 of the two first blocking walls 110 on the left side are the same, and the first heights H1 of the two first blocking walls 110 on the right side are less than the first heights H1 of the two first blocking walls 110 on the left side. The number of the second blocking walls 120 in the second region R2 is six, the second heights H2 of the two second blocking walls 120 on the right side are the same, the second heights H2 of the two second blocking walls 120 in the middle are the same, the second heights H2 of the two second blocking walls 120 on the left side are the same, the second heights H2 of the two second blocking walls 120 on the right side are less than the second heights H2 of the two second blocking walls 120 in the middle, and the second heights H2 of the two second blocking walls 120 in the middle are less than the second heights H2 of the two second blocking walls 120 on the left side. The number of the third blocking walls 130 in the third region R3 is four, the third heights H3 of the two third blocking walls 130 on the right side are the same, the third heights H3 of the two third blocking walls 130 on the left side are the same, and the third heights H3 of the two third blocking walls 130 on the right side are less than the third heights H3 of the two third blocking walls 130 on the left side. However, it is exemplary. The number and the heights of the blocking walls in each region can be adjusted according to practical need. When a region is disposed with a plurality of blocking walls, the heights of the plurality of blocking walls can be the same. Alternatively, the heights of the plurality of blocking walls can be configured to vary gradually along one direction. Alternatively, the heights of a portion of the plurality of blocking walls can be configured to be the same, and the heights of another portion of the plurality of blocking walls can be configured to vary gradually along one direction.

In one embodiment, changing gradually of the heights of the blocking walls adjacent to each other in each region can satisfy the following formula. Select any two blocking walls (adjacent or not adjacent to each other) in an identical region. The difference of the heights between the two blocking walls is H, the number of blocking walls covered by the two blocking walls is Q, then the difference of the heights between any two adjacent blocking walls in the region can satisfy the following formula: [H/(Q−1)]×(1+20%).

In the embodiment, the structures of the first blocking wall 110, the second blocking wall 120 and the third blocking wall 130 are configured to allow the emitting directions of the first emitting light E1, the second emitting light E2 and the third emitting light E3 to vary gradually. Herein, the angles of the first right boundary ray L11, the second right boundary ray L21 and the third right boundary ray L31 deviating from the normal direction N decrease gradually, the angles of the first left boundary ray L12, the second left boundary ray L22, and the third left boundary ray L32 deviating from the normal direction N decrease gradually, and the coverage ranges of the first emitting light E1, the second emitting light E2 and the third emitting light E3 vary gradually. Herein, the coverage ranges of the first emitting light E1, the second emitting light E2 and the third emitting light E3 decrease gradually. For other details of the optical film 100b in FIG. 3, reference may be made to that of the optical film 100a in FIG. 2, and are not repeated here. Moreover, the “±20%” in the aforementioned formula can be ±15%, ±10%, ±5%, ±3%, ±2%, ±1% or ±0.5% in other embodiments, but not limited thereto.

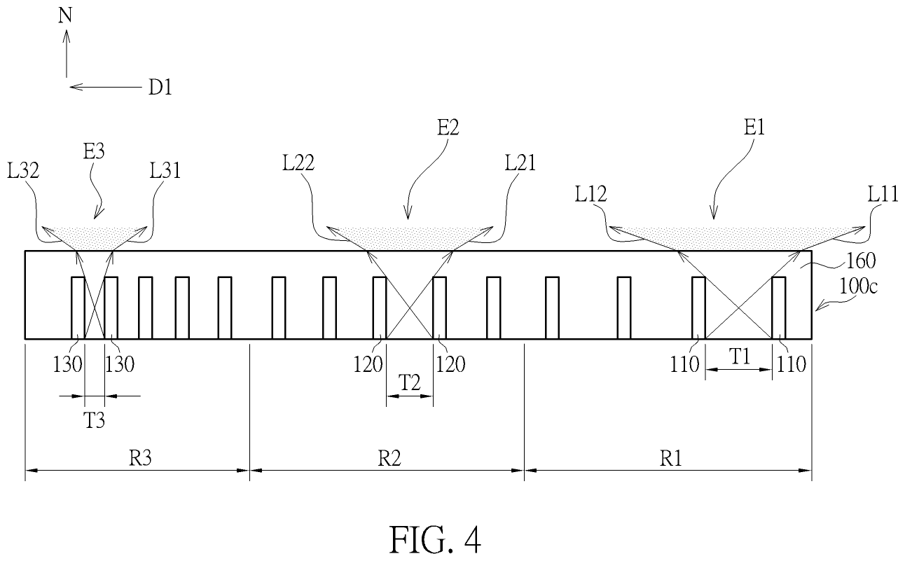

Please refer to FIG. 4, which is a schematic diagram showing a partial cross-sectional view of an optical film 100c according to an embodiment of the present disclosure. The optical film 100c can be applied to the electronic device 10 in FIG. 1. That is, the optical film 100 in FIG. 1 can be the optical film 100c. The electronic device 10 has a first region R1, a second region R2 and a third region R3 arranged in sequence along a direction D1. Since the electronic device 10 includes the optical film 100c, the first region R1, the second region R2 and the third region R3 can also correspond to the optical film 100c and arranged in sequence along the direction D1. Herein, the first region R1, the second region R2 and the third region R3 are disposed continuously from one end (such as the right end in FIG. 4) to the other end (such as the left end in FIG. 4) of the optical film 100c, which is exemplary. The optical film 100c includes a first blocking wall 110, a second blocking wall 120 and a third blocking wall 130 respectively corresponding to the first region R1, the second region R2 and the third region R3, and the first blocking wall 110, the second blocking wall 120 and the third blocking wall 130 are configured to vary gradually in structures. The number of the first blocking walls 110 is greater than or equal to two, the number of the second blocking walls 120 is greater than or equal to two, and the number of the third blocking walls 130 is greater than or equal to two. A first interval T1 is between two of the first blocking walls 110 adjacent to each other, a second interval T2 is between two of the second blocking walls 120 adjacent to each other, a third interval T3 is between two of the third blocking walls 130 adjacent to each other, the first interval T1 is greater than the second interval T2, and the second interval T2 is greater than the third interval T3. In other words, in the embodiment, the first blocking walls 110, the second blocking walls 120 and the third blocking walls 130 are configured to allow the intervals to vary gradually. The aforementioned interval between two blocking walls may be a distance between two opposite surfaces of two adjacent blocking walls in a direction perpendicular to the normal direction N. When the first interval T1, the second interval T2 and the third interval T3 are compared, the first interval T1, the second interval T2, and the third interval T3 are located at the same horizontal level.

In FIG. 4, the number of the first blocking walls 110 in the first region R1 is four, and the first intervals T1 between two adjacent first blocking walls 110 decrease gradually along the direction D1. The number of the second blocking walls 120 in the second region R2 is five, and the second intervals T2 between two adjacent second blocking walls 120 decrease gradually along the direction D1. The number of the third blocking walls 130 in the third region R3 is five, and the third intervals T3 between two adjacent third blocking walls 130 decreases gradually along the direction D1. However, it is exemplary. The number of the blocking walls and the intervals between two adjacent blocking walls in each region can be adjusted according to practical needs. The intervals between any two adjacent blocking walls in the same region can be the same. Alternatively, the intervals between any two adjacent blocking walls in the same region can be configured to vary gradually along one direction. Alternatively, a portion of the intervals in the same region can be configured to be the same, and another portion of the intervals in the same region can be configured to vary gradually along one direction.

In one embodiment, changing gradually of the intervals between two adjacent blocking walls in each region can be defined by the following formula. Select any two blocking walls (adjacent or not adjacent to each other) in an identical region, the interval between the two blocking walls is T, the number of blocking walls covered by the two blocking walls is Q, then the interval between any two adjacent blocking walls in the region can satisfy the following formula: [T/(Q−1)]×(1±20%).

In the embodiment, the structures of the first blocking wall 110, the second blocking wall 120 and the third blocking wall 130 are configured to allow the emitting directions of the first emitting light E1, the second emitting light E2 and the third emitting light E3 to vary gradually. Herein, the angles of the first right boundary ray L11, the second right boundary ray L21 and the third right boundary ray L31 deviating from the normal direction N decrease gradually, the angles of the first left boundary ray L12, the second left boundary ray L22 and the third left boundary ray L32 deviating from the normal direction N decrease gradually, and the coverage ranges of the first emitting light E1, the second emitting light E2 and the third emitting light E3 vary gradually. Herein, the coverage ranges of the first emitting light E1, the second emitting light E2 and the third emitting light E3 decrease gradually. For other details of the optical film 100c in FIG. 4, reference may be made to that of the optical film 100a in FIG. 2 and the optical film 100b in FIG. 3, and are omitted herein. Moreover, the “±20%” in the aforementioned formula can be ±15%, ±10%, ±5%, ±3%, ±2%, ±1% or ±0.5% in other embodiments, but not limited thereto.

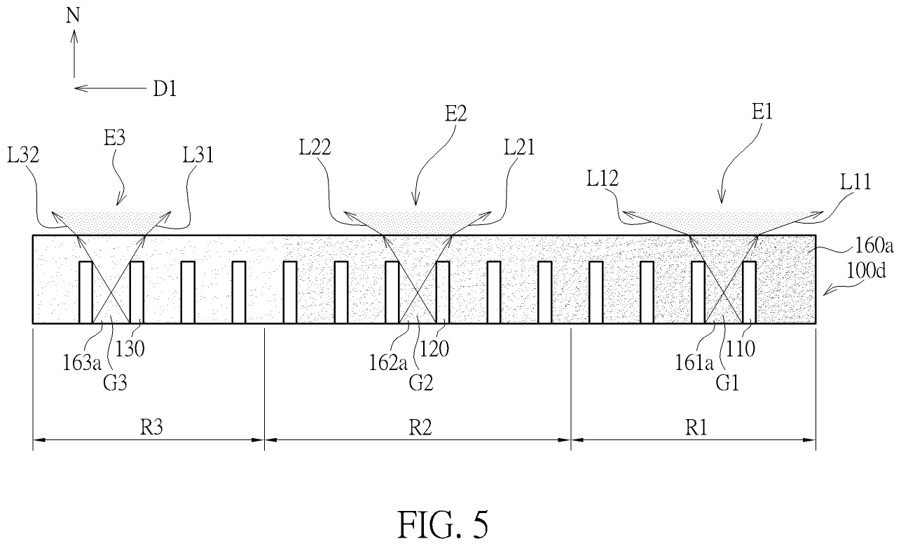

Please refer to FIG. 5, which is a schematic diagram showing a partial cross-sectional view of an optical film 100d according to an embodiment of the present disclosure. The optical film 100d can be applied to the electronic device 10 in FIG. 1. That is, the optical film 100 in FIG. 1 can be the optical film 100d. In FIG. 5, the density of the sprinkle dots is used to represent the value of the refractive index. The higher density represents a larger refractive index. The electronic device 10 has a first region R1, a second region R2 and a third region R3 arranged in sequence along a direction D1. Since the electronic device 10 includes the optical film 100d, the first region R1, the second region R2 and the third region R3 can also correspond to the optical film 100d and arranged in sequence along the direction D1. Herein, the first region R1, the second region R2 and the third region R3 are disposed continuously from one end (such as the right end in FIG. 5) to the other end (such as the left end in FIG. 5) of the optical film 100d, which is exemplary. The optical film 100d includes a first blocking wall 110, a second blocking wall 120 and a third blocking wall 130 respectively corresponding to the first region R1, the second region R2 and the third region R3. The optical film 100d may further include a transparent portion 160a, and the first blocking wall 110, the second blocking wall 120 and the third blocking wall 130 are disposed in the transparent portion 160a. Specifically, the transparent portion 160a may include a first transparent portion 161a, a second transparent portion 162a and a third transparent portion 163a. The first transparent portion 161a has a first refractive index and corresponds to the first region R1. The second transparent portion 162a has a second refractive index and corresponds to the second region R2. The third transparent portion 163a has a third refractive index and corresponds to the third region R3. The first refractive index is greater than the second refractive index, and the second refractive index is greater than the third refractive index. Thereby, the emitting directions of the first emitting light E1, the second emitting light E2 and the third emitting light E3 vary gradually. Herein, the angles of the first right boundary ray L11, the second right boundary ray L21 and the third right boundary ray L31 deviating from the normal direction N decrease gradually, the angles of the first left boundary ray L12, the second left boundary ray L22, and the third left boundary ray L32 deviating from the normal direction N decrease gradually, and the coverage ranges of the first emitting light E1, the second emitting light E2 and the third emitting light E3 vary gradually. Herein, the coverage ranges of the first emitting light E1, the second emitting light E2 and the third emitting light E3 decrease gradually. The first transparent portion 161a, the second transparent portion 162a and the third transparent portion 163a can be optionally formed by the same or different processes. For example, the gap G1 between two adjacent first blocking walls 110 can be filled with a material having the first refractive index to form the first transparent portion 161a, and then the gap G2 between two adjacent second blocking walls 120 can be filled a material having the second refractive index to form the second transparent portion 162a, and then the gap G3 between two adjacent third blocking walls 130 can be filled with a material having the third refractive index to form the third transparent portion 163a, but the order of the processes is not limited thereto. The refractive index of the transparent portion 160a may be 1.45 to 1.65, but not limited thereto. For other details of the optical film 100d in FIG. 5, reference may be made to that of the optical film 100a in FIG. 2, the optical film 100b in FIG. 3 and the optical film 100c in FIG. 4, and are not repeated herein.

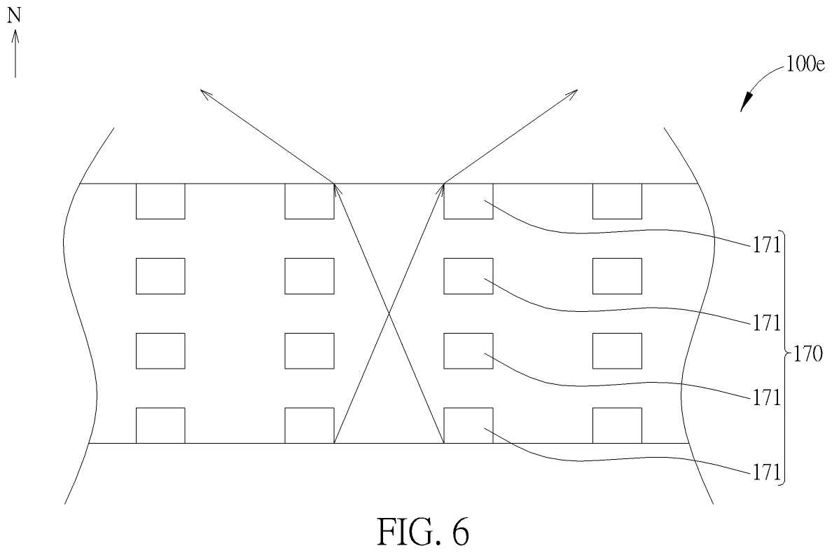

Please refer to FIG. 6, which is a schematic diagram showing a partial cross-sectional view of an optical film 100e according to an embodiment of the present disclosure. Each of the blocking walls 170 includes a plurality of the blocking layers 171, and the plurality of the blocking layers 171 are arranged along the normal direction N of the optical film 100e and are spaced apart from each other. The blocking walls (such as the first blocking wall 110, the second blocking wall 120 and the third blocking wall 130) in FIG. 2 to FIG. 5 are all exemplary as single-layer structures. However, at least one of the plurality of the blocking walls of the optical film according to the present disclosure can be replaced with the blocking wall 170 according to practical needs.

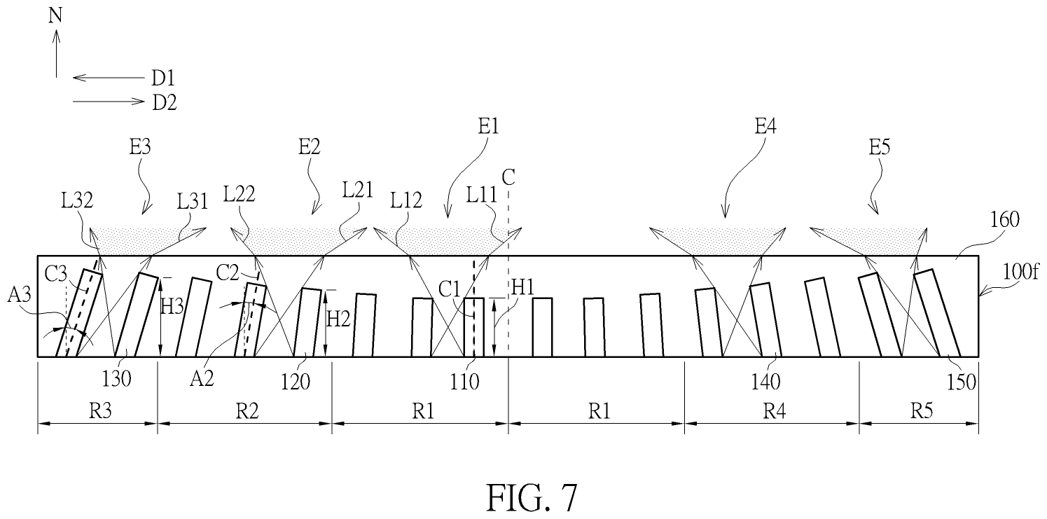

Please refer to FIG. 7, which is a schematic diagram showing a partial cross-sectional view of an optical film 100f according to an embodiment of the present disclosure. The optical film 100f can be applied to the electronic device 10 in FIG. 1. That is, the optical film 100 in FIG. 1 can be the optical film 100f. The electronic device 10 has a first region R1, a second region R2 and a third region R3 arranged in sequence along a direction D1. Since the electronic device 10 includes the optical film 100f, the first region R1, the second region R2 and the third region R3 can also correspond to the optical film 100f and arranged in sequence along the direction D1. Herein, the first region R1, the second region R2 and the third region R3 are disposed continuously from a central axis C of the optical film 100f to one end (such as the left end in FIG. 7) of the optical film 100f, which is exemplary. The optical film 100f includes a first blocking wall 110, a second blocking wall 120 and a third blocking wall 130 respectively corresponding to the first region R1, the second region R2 and the third region R3, and the first blocking wall 110, the second blocking wall 120 and the third blocking wall 130 are configured to vary gradually in structures. A first angle (not label) is included between the first blocking wall 110 and the normal direction N, a second angle A2 is included between the second blocking wall 120 and the normal direction N, a third angle A3 is included between the third blocking wall 130 and the normal direction N, the first angle A1 is less than the second angle A2, and the second angle A2 is less than the third angle A3. The first blocking wall 110 has a first height H1, the second blocking wall 120 has a second height H2, the third blocking wall 130 has a third height H3, the first height H1 is less than the second height H2, and the second height H2 is less than the third height H3. In other words, both the inclined angles relative to the normal direction N and the heights of the first blocking wall 110, the second blocking wall 120 and the third blocking wall 130 are configured to vary gradually, the effect for improving the test and adjusting the light shape of the electronic device 10 can be enhanced. When the blocking wall is inclined relative to the normal direction N, the height of the blocking wall can be the length of the blocking wall in the normal direction N. The electronic device 10 may further have another first region R1, a fourth region R4 and a fifth region R5 located on the right side of the central axis C. The optical film 100f may further include a fourth blocking wall 140 and a fifth blocking wall 150 respectively corresponding to the fourth region R4 and the fifth region R5. The fourth region R4 has a fourth emitting light E4. The fifth region R5 has a fifth emitting light E5. In the embodiment, the central region of the electronic device 10 is preset as the main view region. Herein, the first blocking walls 110 of the two first region R1 are configured to be symmetrical with respect to the central axis C, the fourth blocking walls 140 and the second blocking walls 120 are configured to be symmetrical with respect to the central axis C, the fifth blocking walls 150 and the third blocking walls 130 are configured to be symmetrical with respect to the central axis C, such that the two first emitting lights E1 are symmetrical with respect to the central axis C, the fourth emitting light E4 and the second emitting light E2 are symmetrical with respect to the central axis C, and the fifth emitting light E5 and the third emitting light E3 are symmetrical with respect to the central axis C. However, the present disclosure is not limited thereto. In other embodiment, the fourth emitting light E4 and the second emitting light E2, the fifth emitting light E5 and the third emitting light E3 can be asymmetrically with respect to the central axis C.

In other embodiments, the inclined angles relative to the normal direction N of the first blocking wall 110, the second blocking wall 120 and the third blocking wall 130 are configured to vary gradually, meanwhile at least one of the heights of the blocking walls, the intervals between the blocking walls, the refractive indexes of the transparent portions is configured to vary gradually, such that effect for improving the taste and adjusting the light shape of the electronic device 10 can be enhanced. For other details of the optical film 100f in FIG. 7, reference may be made to that of the optical film 100a in FIG. 2, the optical film 100b in FIG. 3, the optical film 100c in FIG. 4 and the optical film 100d in FIG. 5, and are omitted herein.

Furthermore, in the present disclosure, the first emitting light E1, the second emitting light E2 and the third emitting light E3 are configured to vary gradually. Thereby, it is beneficial to control the emitting direction of the emitting light of the electronic device, such that the emitting light of the electronic device can emit toward the user. The aforementioned “the first emitting light E1, the second emitting light E2 and the third emitting light E3 are configured to vary gradually” may refer that the emitting directions of the emitting lights are configured to vary gradually, and other characteristics, such as the light shapes, the main angles, the full widths at half maximum and/or the normal intensity can be configured to vary gradually, which are explained in detail below.

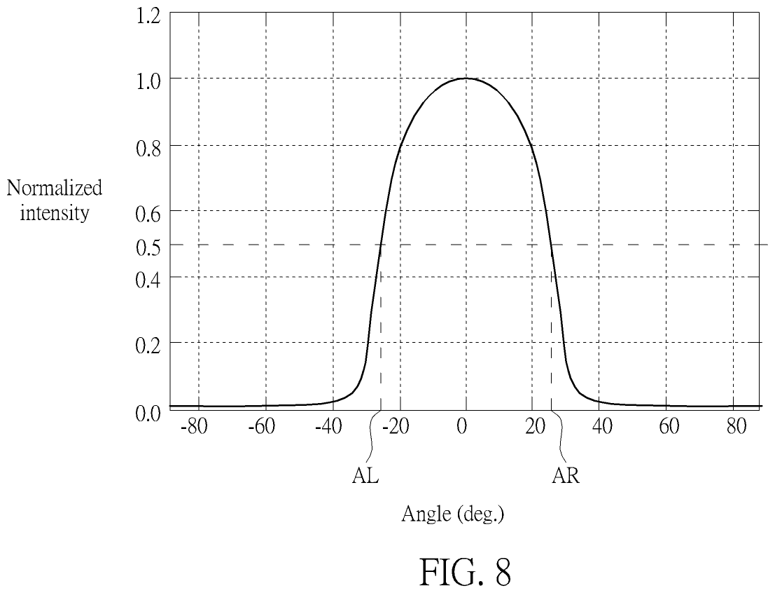

Please refer to FIG. 8, which is an intensity-angle distribution diagram of an emitting light according to an embodiment of the present disclosure and can be depicted as follows. An optical angle measuring instrument (for example, an optical angle measuring instrument of model WP_Conometer 80) is used to measure the intensities of the emitting light at different angles by using a white light with full RGB grayscale (for example, with fixed grayscales of 255). The intensities of the emitting light are normalized. Take the normalized intensity as the vertical axis, and take the angle as the horizontal axis, the intensity-angle distribution diagram can be obtained, and the curve is the intensity curve of the emitting light.

After normalization, the maximum intensity of the emitting light is 1 (i.e. 100%). Herein, the angle corresponding to the maximum intensity is 0 degree, the angle on the right side of 0 degree and corresponding to 50% of maximum intensity (i.e., 0.5 or 50%) is the right boundary angle AR, and the angle on the left side of 0 degrees and corresponding to 50% of the maximum intensity (i.e., 0.5 or 50%) is the left boundary angle AL. The definitions of a full width at half maximum (FWHM) and a main angle (MA) are as the following Formulas (1) and (2): FWHM=abs (AL−AR) degrees (1); and MA=0.5 (AL+AR) degrees (2).

In other words, the emitting light of each region can define a full width at half maximum and a main angle. The definition of the full width at half maximum is the absolute value of the difference between two angles, wherein one of the angles is included between the direction on the right side of the normal direction and corresponding to 50% of maximum intensity and the normal direction, and the other one of the angles is included between the direction on the left side of the normal direction and corresponding to 50% of maximum intensity and the normal direction. The definition of the main angle is the average value of two angles, wherein one of the angles is included between the direction on the right side of the normal direction and corresponding to 50% of maximum intensity and the normal direction, and the other one of the angles is included between the direction on the left side of the normal direction and corresponding to 50% of maximum intensity and the normal direction. Take FIG. 8 as an example. In FIG. 8, AR=25 degrees, AL=−25 degrees, FWHM=abs (−25−25)=50 degrees, MA=0.5 (−25+25)=0 degrees.

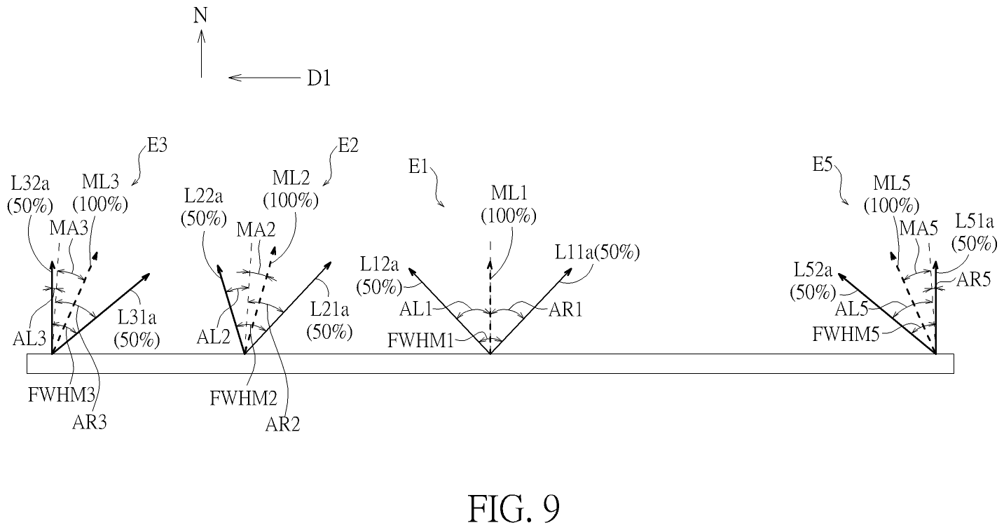

Please refer to FIG. 9, which is a schematic diagram showing light shapes of an electronic device according to an embodiment of the present disclosure. Herein, the electronic device 10 with the optical film 100a shown in FIG. 2 is measured by the optical angle measuring instrument, and the intensity-angle distribution diagrams of the first emitting light E1 of the first region R1, the second emitting light E2 of the second region R2, the third emitting light E3 of the third region R3 and the fifth emitting light E5 of the fifth region R5 are obtained. According to the measuring results, AL, AR, FWHM and MA of the emitting light in each region are shown in Table 1.

TABLE 1

| | The first | The second | The third | The fifth |
|---|---|---|---|---|
| | emitting | emitting | emitting | emitting |
| | light | light | light | light |
| | E1 | E2 | E3 | E5 |
| AL (degree) | −25 | −15 | −5 | −40 |
| AR (degree) | 25 | 33 | 40 | 5 |
| FWHM (degree) | 50 | 47 | 45 | 45 |
| MA (degree) | 0 | 8.5 | 17.5 | −17.5 |

According to the measuring results of Table 1, FIG. 9 can be obtained, wherein the left boundary angles AL of the first emitting light E1, the second emitting light E2, the third emitting light E3 and the fifth emitting light E5 are called the first left boundary angle AL1, the second left boundary angle AL2, the third left boundary angle AL3 and the fifth left boundary angle AL5, respectively, and the right boundary angles AR of the first emitting light E1, the second emitting light E2, the third emitting light E3 and the fifth emitting light E5 are called the first right boundary angle AR1, the second right boundary angle AR2, the third right boundary angle AR3 and the fifth right boundary angle AR5, respectively. The full widths at half maximum FWHM of the first emitting light E1, the second emitting light E2, the third emitting light E3 and the fifth emitting light E5 are called the first full width at half maximum FWHM1, the second full width at half maximum FWHM2, the third full width at half maximum FWHM3 and the fifth full width at half maximum FWHM5, respectively. The main angles MA of the first emitting light E1, the second emitting light E2, the third emitting light E3 and the fifth emitting light E5 are called the first main angle MA1, the second main angle MA2, the third main angle MA3 and the fifth main angle MA5, respectively. In addition, based on the definition of the main angle, it can be seen that the direction of the main angle is identical to, substantially identical to or very close to the direction of the maximum intensity (see FIG. 8). Therefore, in the present disclosure, the direction of the main angle can be the direction of the main angle obtained by the above Formula (2) or the direction of the maximum intensity (1 or 100%).

Herein, the first left ray L12a, the second left ray L22a, the third left ray L32a and the fifth left ray L52a respectively correspond to the direction of 50% of maximum intensity on the left side of the first emitting light E1, the second emitting light E2, the third emitting light E3 and the fifth emitting light E5. The first right ray L11a, the second right ray L21a, the third right ray L31a and the fifth right ray L51a respectively correspond to the direction of 50% of maximum intensity on the right side of the first emitting light E1, the second emitting light E2, the third emitting light E3 and the fifth emitting light E5. The first main ray ML1 of the first emitting light E1 corresponds to the direction of the first main angle MA1 (0 degrees, not shown). The second main ray ML2 of the second emitting light E2 corresponds to the direction of the second main angle MA2. The third main ray ML3 of the third emitting light E3 corresponds to the direction of the third main angle MA3. The fifth main ray ML5 of the fifth emitting light E5 corresponds to the direction of the fifth main angle MA5. As shown in FIG. 9, the first emitting light E1 defines the first main angle MA1, the second emitting light E2 defines the second main angle MA2, the third emitting light E3 defines the third main angle MA3, the first main angle MA1 is less than the second main angle MA2, and the second main angle MA2 is less than the third main angle MA3. The intensity curve of the first emitting light E1 defines the first full width at half maximum FWHM1, the intensity curve of the second emitting light E2 defines the second full width at half maximum FWHM2, the intensity curve of the third emitting light E3 defines the third full width at half maximum FWHM3, the first full width at half maximum FWHM1 is greater than the second full width at half maximum FWHM2, and the second full width at half maximum FWHM2 is greater than the third full width at half maximum FWHM3. In other words, for the electronic device 10 in FIG. 2, from the central region to the peripheral region, the light shapes of the first emitting light E1, the second emitting light E2 and the third emitting light E3 vary gradually from symmetrical to asymmetrical, the main angles of the first emitting light E1, the second emitting light E2 and the third emitting light E3 increase gradually, and the full widths at half maximum of the first emitting light E1, the second emitting light E2 and the third emitting light E3 decrease gradually. That is, the first emitting light E1, the second emitting light E2 and the third emitting light E3 according to the present disclosure are configured to vary gradually. In addition, the first right boundary ray L11 in FIG. 2 has different meanings from the first right ray L11a in FIG. 9. The first right boundary ray L11 in FIG. 2 represents the rightmost ray in the coverage range of the first emitting light E1, and the first right ray L11a in FIG. 9 is on the right side of the first main angle MA1 with 50% of maximum intensity. Similarly, the first left boundary ray L12 in FIG. 2 represents the leftmost ray in the coverage range of the first emitting light E1, and the first left ray L12a in FIG. 9 is on the left side of the first main angle MA1 with 50% of the maximum intensity.

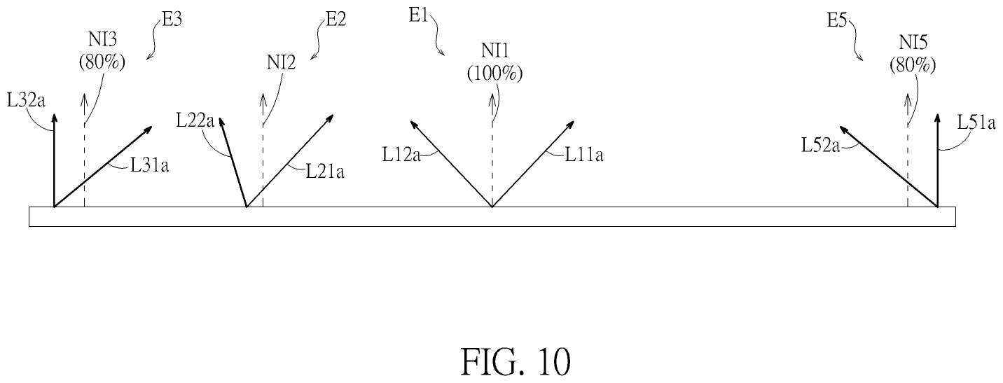

According to the present disclosure, the normal intensity is the intensity in the direction corresponding the angle of 0 degrees (that is, the angle included between the direction and the normal direction N is 0 degrees) in each region. The unit of the normal intensity is candela per square meter (cd/m\hat{ }2) or lumens per steradian per square meter (lm/sr·m\hat{ }2). The normal intensity can be measured by a display color analyzer (such as a display color analyzer with the model ca210), or by an optical angle measuring instrument (such as an optical angle measuring instrument with the model of WP_Conometer 80). Among the normal intensities of all the regions, the greatest one is taken as 100%, and then the percentages of the normal intensities of other regions relative to the greatest one are calculated. Please refer to FIG. 10, which is a schematic diagram showing normal intensities of an electronic device according to an embodiment of the present disclosure. Herein, the optical film 100a in FIG. 2 is applied to the electronic device 10, which is exemplary. According to the measuring results, the first emitting light E1 has a first normal intensity NI1, and the first normal intensity NI1 is 100%. The second emitting light E2 has a second normal intensity NI2, and the second normal intensity NI2 is 90%. The third emitting light E3 has a third normal intensity NI3, and the third normal intensity NI3 is 80%. The fifth emitting light E5 has a fifth normal intensity NI5, and the fifth normal intensity NI5 is 80%. As shown in FIG. 10, when the optical film 100a in FIG. 2 is applied to the electronic device 10, the normal intensities from the central region to the peripheral region decrease gradually. In addition, the light shapes of the emitting lights located on the left sides and the right side of the central axis C (such as the third emitting light E3 and the fifth emitting light E5) are symmetrical, which is exemplary, and the present disclosure is not limited thereto.

As shown in FIG. 9 and FIG. 10, the emitting lights of the electronic device according to the present disclosure are configured to vary gradually along a direction, so as to bring the emitting lights toward the user. For example, the central region of the electronic device is preset as the main view region. That is, when the user uses the electronic device, the user faces the central region of the electronic device. When the size of the display surface of the electronic device is 14 inches, the aspect ratio is 16:10, and the view distance between the user and the display surface is 75 cm, the maximum view angle of 12 degrees can be calculated, then the main angle of the peripheral region can be deflected by 24 degrees relative to the main angle of the central region. Alternatively, when the size of the display surface of the electronic device is 32 inches, the aspect ratio is 16:10, and the view distance between the user and the display surface is 45 cm, the maximum view angle of 37 degrees can be calculated, then the main angle of the peripheral region can be deflected by 74 degrees relative to the main angle of the central region. In other words, the main angle of the peripheral region can be configured to deflect by 20 degrees to 80 degrees relative to the main angle in the central region according to practical needs, such as the size of the display surface of the electronic device and the view distance, which is exemplary, and the present disclosure is not limited thereto.

In the present disclosure, the emitting lights are configured to vary gradually along one direction. The changing gradually may be defined as follow. The intensity-angle distribution diagrams of the emitting lights can be measured every 5 cm to 100 cm along the direction, and the main angles of the emitting lights are calculated. When the difference between two main angles of two adjacent emitting lights is greater than or equal to 2 degrees, it represents that the two adjacent emitting lights vary gradually. Alternatively, the normal intensities of the emitting lights are measured every 5 cm to 100 cm along the direction. When the difference of two normal intensities of two adjacent emitting lights is greater than or equal to 58, it represents that the two adjacent emitting lights vary gradually.

According to the present disclosure, the structure of the blocking wall can be verified by a microscope, such as an optical microscope (OM) or a scanning electron microscope (SEM).

According to the present disclosure, the first blocking wall, the second blocking wall and the third blocking wall are configured to vary gradually in structures. For example, the inclined angles of the blocking walls relative to the normal direction vary gradually, the heights of the blocking walls vary gradually and/or the intervals between the blocking walls vary gradually. Therefore, it is beneficial to control the emitting lights of the electronic device to emit toward the user. The aforementioned characteristic can be cooperated with each other and can be cooperated with the transparent portion with the refractive indexes changing gradually, such that the effect of improving the taste of the electronic device and adjusting the light shapes can be enhanced. According to the present disclosure, with the first emitting light E1, the second emitting light E2 and the third emitting light E3 changing gradually, such as optical characteristics of light shapes, main angles, full widths at half maximum and/or normal intensities, it is also beneficial to control the emitting lights of the electronic device to emit toward the user.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An electronic device, having a first region, a second region and a third region arranged in sequence along a direction, the electronic device comprising:
a panel; and
an optical film disposed corresponding to the panel;
wherein the optical film comprises a first blocking wall, a second blocking wall and a third blocking wall respectively corresponding to the first region, the second region and the third region, and the first blocking wall, the second blocking wall and the third blocking wall are configured to vary gradually in structures.

2. The electronic device of claim 1, wherein the first region has a first emitting light, the second region has a second emitting light, the third region has a third emitting light, and the structures of the first blocking wall, the second blocking wall and the third blocking wall are configured to allow emitting directions of the first emitting light, the second emitting light and the third emitting light to vary gradually.

3. The electronic device of claim 2, wherein the optical film has a normal direction, a first angle is included between the first blocking wall and the normal direction, a second angle is included between the second blocking wall and the normal direction, a third angle is included between the third blocking wall and the normal direction, the first angle is less than the second angle, and the second angle is less than the third angle.

4. The electronic device of claim 2, wherein the first blocking wall has a first height, the second blocking wall has a second height, the third blocking wall has a third height, the first height is less than the second height, and the second height is less than the third height.

5. The electronic device of claim 2, wherein a number of the first blocking walls is greater than or equal to two, a number of the second blocking walls is greater than or equal to two, a number of the third blocking walls is greater than or equal to two, a first interval is between two of the first blocking walls adjacent to each other, a second interval is between two of the second blocking walls adjacent to each other, a third interval is between two of the third blocking walls adjacent to each other, the first interval is greater than the second interval, and the second interval is greater than the third interval.

6. The electronic device of claim 2, wherein light shapes of the first emitting light, the second emitting light and the third emitting light vary gradually.

7. The electronic device of claim 6, wherein asymmetry degrees of the coverage ranges of the first emitting light, the second emitting light and the third emitting light increase gradually.

8. The electronic device of claim 2, further having another first region, a fourth region and a fifth region arranged in sequence along another direction opposite to the direction, wherein the optical film further comprises another first blocking wall, a fourth blocking wall and a fifth blocking wall respectively corresponding to the another first region, the fourth region and the fifth region, and the another first blocking wall, the fourth blocking wall and the fifth blocking wall are configured to vary gradually in structures.

9. The electronic device of claim 8, wherein the optical film has a central axis, the first blocking wall and the another first blocking wall are configured to be symmetrical with respect to the central axis, the second blocking wall and the fourth blocking wall are configured to be symmetrical with respect to the central axis, and the third blocking wall and the fifth blocking wall are configured to be symmetrical with respect to the central axis.

10. The electronic device of claim 1, wherein the optical film further comprises a transparent portion, the first blocking wall, the second blocking wall and the third blocking wall are disposed in the transparent portion, the transparent portion comprises a first refractive index, a second refractive index and a third refractive index respectively corresponding to the first region, the second region and the third region, the first refractive index is greater than the second refractive index, and the second refractive index is greater than the third refractive index.

11. The electronic device of claim 1, wherein the optical film has a normal direction, at least one of the first blocking wall, the second blocking wall and the third blocking wall comprises a plurality of blocking layers arranged along the normal direction and spaced apart from each other.

12. The electronic device of claim 1, wherein the first region, the second region and the third region are arranged from a central region of the electronic device to a peripheral region of the electronic device.

13. The electronic device of claim 1, wherein the first region, the second region and the third region are arranged from a peripheral region of the electronic device to another peripheral region of the electronic device.

14. An electronic device, having a first region, a second region and a third region arranged in sequence along a direction, the electronic device comprising:
a panel; and
an optical film disposed corresponding to the panel;
wherein the first region has a first emitting light, the second region has a second emitting light, the third region has a third emitting light, and the first emitting light, the second emitting light and the third emitting light are configured to vary gradually.

15. The electronic device of claim 14, wherein the first emitting light has a first normal intensity, the second emitting light has a second normal intensity, the third emitting light has a third normal intensity, the first normal intensity is greater than the second normal intensity, and the second normal intensity is greater than the third normal intensity.

16. The electronic device of claim 14, wherein the first emitting light defines a first main angle, the second emitting light defines a second main angle, the third emitting light defines a third main angle, the first main angle is less than the second main angle, and the second main angle is less than the third main angle.

17. The electronic device of claim 14, wherein in an intensity-angle distribution diagram, an intensity curve of the first emitting light defines a first full width at half maximum, an intensity curve of the second emitting light defines a second full width at half maximum, an intensity curve of the third emitting light defines a third full width at half maximum, the first full width at half maximum is greater than the second full width at half maximum, and the second full width at half maximum is greater than the third full width at half maximum.

18. The electronic device of claim 14, wherein light shapes of the first emitting light, the second emitting light and the third emitting light vary gradually.

19. The electronic device of claim 14, wherein the first region, the second region and the third region are arranged from a central region of the electronic device to a peripheral region of the electronic device.

20. The electronic device of claim 14, wherein the first region, the second region and the third region are arranged from a peripheral region of the electronic device to another peripheral region of the electronic device.
